(19) United States
(12) Patent Application Publication
(10) Pub. No.: US 2015/0329042 A1
(43) Pub. Date: Nov. 19, 2015

(54) DISPLAY DEVICE

(71) Applicant: DENSO CORPORATION, Kariya-city, Aichi (JP)

(72) Inventor: Teruaki ARAKI, Kariya-city (JP)

(73) Assignee: DENSO CORPORATION, Kariya-city, Aichi-pref. (JP)

(21) Appl. No.: 14/649,926

(22) PCT Filed: Oct. 2, 2013
(86) PCT No.: PCT/JP2013/005867

§ 371 Date: Jun. 5, 2015

(30) Foreign Application Priority Data
Dec. 6, 2012 (JP) 2012-267576

(51) Int. Cl. B60Q 3/04; B60K 35/00

(52) U.S. Cl. CPC B60Q 3/044; B60K 35/00; B60K 2350/2039

(57) ABSTRACT

A display device including a plurality of light-emitting elements provided to one surface side of a substrate, a display panel having a plurality of light-transmitting units for transmitting light emitted from light-emitting units, respectively, in the plurality of light-emitting elements, the display panel being disposed to face the one surface of the substrate, and a light-blocking wall disposed between the substrate and the display panel in a position corresponding to the space between mutually adjacent light-emitting elements. A gap is present between the one surface of the substrate and the distal end of the light-blocking wall on the substrate side. The light-emitting units are disposed closer to the display panel than the gap is to the display panel. Light can therefore be suppressed from leaking from the gap formed between the substrate and the light-blocking wall.

### CROSS-REFERENCE TO RELATED APPLICATION

The present application is based on Japanese patent application No. 2012-267576 filed on Dec. 6, 2012, the content of which is incorporated herein by reference.

### TECHNICAL FIELD

The present disclosure relates to a display device suitable for use in, e.g., a combination meter of a vehicle.

### BACKGROUND ART

Conventional display devices, such as those disclosed in Patent Literature 1, are known. The display device of Patent Literature 1 includes a plurality of surface mounted light-emitting elements, disposed in a line on one surface of a substrate, that emit diffused light from light-emitting surfaces. In addition, this display device includes a design panel, disposed to face the one surface of the substrate, having formed thereon light-emitting openings at locations corresponding to each of the plurality of light-emitting element, and a light-blocking portion (light-blocking wall), interposed between each light-emitting element, having one end joined to the substrate and the other end extending toward the design panel.

In the display device of Patent Literature 1, light emitted from each light-emitting element passes through a corresponding light-emitting opening so as to be visible from an exterior side of the design panel. In addition, the display device includes light-blocking walls that suppress light emitted by the light-emitting elements from leaking through corresponding display openings of neighboring light-emitting elements. Accordingly, the display device can be suppressed from emitting light in an unintended manner due to leaked light from neighboring light-emitting openings.

### PRIOR ART LITERATURE

### Patent Literature

Patent Literature 1: JP 2004-312049 A

### SUMMARY OF THE INVENTION

However, from consideration by the inventor of the present application, if the light-blocking wall is formed so as to extend from the design panel toward the substrate, in the space between the substrate and the end of the light-blocking wall at the substrate side, an unavoidable gap will form due to size variations in the manufacturing process. If such a gap forms, there is a danger of light from the light-emitting elements leaking through the gap toward neighboring light-emitting elements. If light from the light-emitting elements leaks toward neighboring light-emitting elements, this will lead to the display device emitting light in an unintended manner. Alternatively, if an incomplete amount of light leaking occurs, there is a possibility that the display device will emit light in an ambiguous manner and lower the reliability of the display device.

It is an object of the present disclosure to, in view of the above points, provide a display device that is capable of suppressing light leaking through a gap formed between the substrate and the light-blocking wall.

A first aspect of the present disclosure includes a substrate, a plurality of light-emitting elements including a light-emitting unit and provided on a mounting surface of the substrate, a display panel arranged to face the mounting surface of the substrate, a plurality of light-transmitting units provided on the display panel with respect to the plurality of light-emitting elements, the plurality of light-transmitting units allowing light emitted from the light-emitting unit to transmit therethrough, and a light-blocking wall provided at a location corresponding to a space between mutually adjacent ones of the plurality of light-emitting elements, the light-blocking wall being positioned between the substrate and the display panel, wherein a gap is defined between the mounting surface of the substrate and a facing end surface of the light-blocking wall that faces the substrate, and the light-emitting unit is disposed closer to the display panel than the gap is to the display panel.

If the light-emitting units and the gap are arranged at an equal position in a direction from the substrate to the display panel, of the light emitted by one light-emitting unit, the light that advances in a direction along the mounting surface of the substrate will pass through the gap to reach the neighboring light-emitting elements. That is, there is a possibility that light will leak through the gap.

However, according to the present disclosure, the light-emitting units are disposed closer to the display panel than the gap is to the display panel. Accordingly, of the light emitted by one light-emitting unit, the light that advances in a direction along the mounting surface of the substrate will be blocked by the light-blocking wall, and it is possible to suppress light from leaking through the gap.

### BRIEF DESCRIPTION OF THE DRAWINGS

FIG. 1 is a sectional view illustrating a warning display unit according to a first embodiment of the present disclosure.

FIG. 2 is a sectional view illustrating the refractive state of light due to a slanted portion of a potting portion.

FIG. 3 is a sectional view illustrating a warning display unit according to a second embodiment of the present disclosure.

### EMBODIMENTS FOR CARRYING OUT INVENTION

Hereinafter, a plurality of embodiments for embodying the present disclosure will be described with reference to the accompanying drawings. The same reference numerals are given to parts of each embodiment, which correspond to parts described in the preceding embodiment, and the description thereof will not be repeated in some cases. When only a part of the configuration is described in each embodiment, the configurations of other preceding described embodiments can be applied to the remaining parts of the configuration. The combinations of parts are not limited to those specifically shown in each embodiment as being able to be combined. Even when there is no description, the embodiments can also be used in partial combination as long as there is not a problem in combination.

### First Embodiment

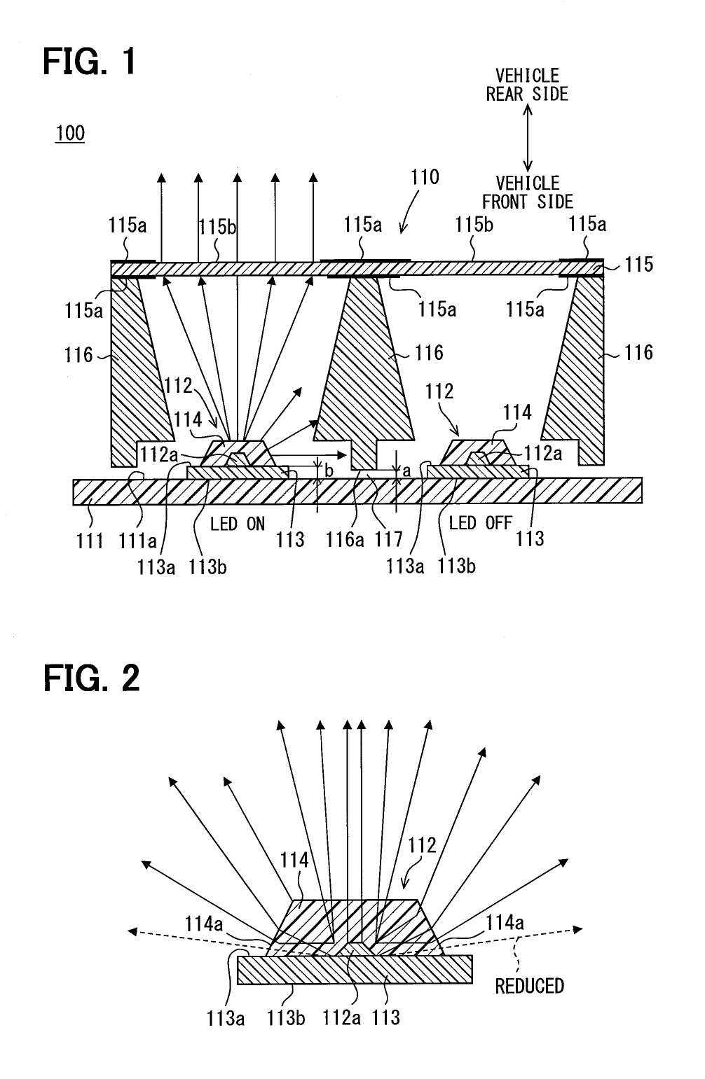

For a display device of the first embodiment, FIGS. 1 and 2 will be used for the explanation. The display device of the present embodiment is, as an example, applied as a warning display unit 110 disposed within a vehicle combination meter 100. When a situation occurs where the passengers of a vehicle should be warned of that situation, the warning display unit 110 will cause cut-out portions 115b (warning mark) in a display panel 115 to illuminate, by way of light-emitting elements 112, as warning information in order to promptly inform the passengers. The warning information may be, for example, engine oil pressure warning, brake warning, door ajar warning, seatbelt warning, remaining fuel level warning and the like.

As illustrated in FIG. 1, the warning display unit 110 includes a printed substrate 111, the light-emitting elements 112, a display panel 115, light-blocking walls 116 and the like.

Along with the light-emitting elements 112, various other kinds of electrical components are fixed on the surface (hereinafter “substrate surface”) 111a of one side of the printed substrate 111. The substrate surface 111a is formed as a flat surface. The printed substrate 111 corresponds to the substrate of the present disclosure, and the substrate surface 111a corresponds to the mounting surface of the present disclosure.

The light-emitting elements 112 are semiconductor elements that emit light in a predetermined color (e.g., red) for warning purposes when a voltage is applied thereto. For example, light-emitting diodes (Light Emitting Diode) are used. The light-emitting elements 112 include a semiconductor chip 112a (light-emitting unit), a chip base 113 (light-emitting substrate), and a potting portion 114. The semiconductor chip 112a is implemented on the surface (a first surface) 113a of one side of the chip base 113. The semiconductor chip 112a is covered by the potting portion 114 on the first surface 113a of the chip base 113.

The semiconductor chip 112a can be, for example, an ultra-small light-emitting portion having a base dimension of several hundred microns. In addition, the chip base 113 is a substrate having formed thereon anode and cathode printed wiring for use with the light-emitting portion. The semiconductor chip 112a is connected to one side of the printed wiring on the chip base 113 and connected to other printed wiring through a wire lead.

The potting portion 114 is formed from transparent resin materials having translucency. The exterior shape of the potting portion 114 is based on a rectangular solid, wherein the side portions (the circumferential surface portions of the rectangular solid) slant toward a side of the light-emitting elements 112 (a side of the center) in a direction from the printed substrate 111 to the display panel 115 which is described later. This slanted portion is hereinafter known as slant portion 114a.

Furthermore, depending on the applications of the light-emitting element 112, diffusion particles for diffusing light may be provided within the potting portion 114 in order to actively diffuse the emitted light in all directions. However, such diffusion particles are not used in the present embodiment. Conversely, reflectors may be provided on the sides of the potting portion 114 in order to direct light from the semiconductor chip 112a primarily toward the display panel 115. However, such reflectors are not used in the present embodiment. The light-emitting elements 112 are provided on the printed substrate 111 since the surface (a second surface) 113b of the other side of the chip base 113 is joined to a predetermined position on the substrate surface 111a by, e.g., soldering. As such, the light-emitting elements 112 are directly joined to the printed substrate 111 as surface mounted type (Surface Mount Devicd=SMD) light-emitting elements. The light-emitting elements 112 are multiply arranged in a relatively high density fashion on the substrate surface 111a.

The chip base 113 is positioned between the printed substrate 111 and the semiconductor chip 112a. The thickness of the chip base 113 is predetermined and set at thickness ‘b’ (details below). That is, due to the chip base 113, the semiconductor chip 112a is located at a position raised from the substrate surface 111a by thickness ‘b’.

The display panel 115 is positioned to face the substrate surface 111a and is a panel member (display design panel) for illuminating various warning displays by way of light emitted from the semiconductor chip 112a. The display panel 115 is formed from translucent resin materials, and printed portions 115a and the cut-out portions 115b are formed on front and rear surfaces of the display panel 115.

The printed portions 115a are formed by printing light-blocking, e.g., black ink, or possibly paints and the like on the display panel 115 at locations corresponding to the space between neighboring light-emitting elements 112. The cut-out portions 115b correspond to the light-transmitting units of the present disclosure. The cut-out portions 115b are formed on the display panel 115 at locations corresponding to (facing) each of the light-emitting elements 112. These cut-out portions 115b retain translucency on the display panel 115 by removing the aforementioned ink or paints and the like, or possibly by low transmission density printing. These cut-out portions 115b are formed in the marking shape of various kinds of warning displays. As such, when the semiconductor chip 112a emits light, the cut-out portions 115b illuminate in the marking shape for warning displays, and the passengers are able to visually recognize these marking shapes.

Furthermore, by setting the transmission density printed for the cut-out portions 115b to a suitable value, when the semiconductor chip 112a is not emitting light, the cut-out portions 115b on the display panel 115 will be viewed as being blacked out. The light-blocking walls 116 are partitioning members positioned between the printed substrate 111 and the display panel 115 as well as positioned in at locations corresponding to the spaces between mutually adjacent light-emitting elements 112. The aforementioned display panel 115 and the light-blocking walls 116 form a case portion of the warning display unit 110.

Here, when manufacturing the printed substrate 111 and the light-blocking walls 116, measurement errors in, e.g., the flatness of the printed substrate 111, the lengthwise dimension (up-down direction in FIG. 1) of the light-blocking walls, and the like, can occur. Accordingly, a gap 117 can form (exist) in between the substrate surface 111a and the distal end portion 116a (facing end surface) of the light-blocking walls 116 at the side of the printed substrate 111 (substrate surface 111a). The gap 117 has a maximum dimension ‘a’ of about 0.3 mm in the current embodiment.

It should be noted that various sensors, not illustrated, are provided in fixed positions in the vehicle. Additionally, a signal receiver and a controller, not illustrated, are provided in the vehicle combination meter 100. Various abnormality signals are output by the various sensors and input to the controller through the signal receiver. Then, based on these abnormality signals, the controller causes the semiconductor chip 112a of the light-emitting element 112 corresponding to the received abnormality signal to emit light.

Next, FIG. 2 is used to explain the operation of the warning display unit 110 based on the above described structure.

When the ignition switch of the vehicle is turned on, the controller receives electrical power from a power supply and starts up. The controller monitors abnormality signals from the various sensors and, during the state when no abnormality signal is generated, the controller maintains the light-emitting elements 112 in an off state. Accordingly, the cut-out portions (warning marks) 115b on the display panel 115 are not illuminated, and the passengers can continue to drive in peace.

However, if any abnormality signal is sent from the various sensors, the controller causes the semiconductor chip 112a of the light-emitting element 112 corresponding to that abnormality signal to emit light. If this occurs, light is emitted from the semiconductor chip 112a in all directions toward the display panel 115 side of the chip base 113.

Then, when the light is heading toward the display panel 115, the light is suppressed by the light-blocking walls 116 from intruding into the areas where neighboring light-emitting elements 112 are provided, and transmit through the cut-out portion 115b corresponding to the aforementioned light-emitting element 112. Therefore, the cut-out portion 115b becomes illuminated, and the passengers are informed of the content of this abnormality.

Here, in the current embodiment, it was explained that unavoidable gaps 117 form between the substrate surface 111a and the distal end portions 116a due to size variations during manufacturing. Then, it is assumed that in a direction from the substrate 111 to the display panel 115, the semiconductor chips 112a and the gaps 117 are arranged at an equal position (in FIG. 1, a position within the range of height ‘a’). In this case, of the light emitted by one semiconductor chip 112a, the light that advances in a direction along the substrate surface 111a would pass through the gaps 117 and intrude into the side of neighboring light-emitting elements 112. That is, light leakage would occur through the gaps 117.

However, according to the present disclosure, the plurality of semiconductor chips 112a are disposed closer to the display panel 115 than the gaps 117 are to the display panel 115 (range of ‘a’). In other words, the first surface 113a of the chip base 113 is disposed closer to the display panel 115 than the distal end portion 116a is to the display panel 115. Accordingly, of the light emitted by one semiconductor chip 112a, the light that advances in a direction along the substrate surface 111a will be blocked by the light-blocking walls 116, and light can be suppressed from leaking through the gaps 117.

The plurality of semiconductor chips 112a can be disposed closer to the display panel 115 than the gaps 117 are to the display panel 115 as described above by setting the thickness of the chip bases 113. That is, the thickness ‘b’ of the chip bases 113 can be set to be larger than the dimension ‘a’ of the gaps 117 to easily position the semiconductor chips 112a closer to the display panel 115 than the gaps 117 are to the display panel 115. In other words, the distance between the first surface 113a and the second surface 113b is set so that the first surface 113a of the chip base 113 is disposed closer to the display panel 115 than the distal end portion 116a is to the display panel 115.

Furthermore, the present inventor recognized through actual experimental observation that if, for example, the gaps 117 have a maximum dimension ‘a’ of 0.3 mm, the position of the semiconductor chips 112a, that is, the thickness ‘b’ of the chip bases 113, is preferably 0.5 mm or greater, and the thickness ‘b’ of the chip bases 113 is more preferably 0.8 mm or greater.

In addition, as illustrated in FIG. 2, the potting portion 114 covering the semiconductor chip 112a has provided thereon slant portions 114a, thus the light emitted from the semiconductor chip 112a is refracted by the slant portions 114a and the direction of the light is bent toward the display panel 115. Accordingly, the light directed toward the light-blocking walls 117 (the light illustrated in FIG. 2 as dotted line arrows) is reduced, and it is possible to further suppress light from leaking through the gaps 117.

### Second Embodiment

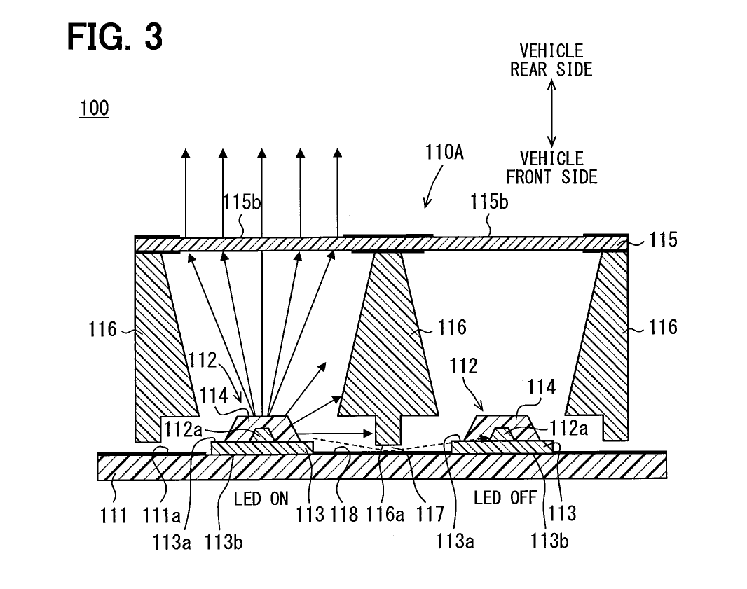

A second embodiment, a warning display unit 110A, is illustrated in FIG. 3. The second embodiment has, with respect to the first embodiment described above, additional reflection suppressors 118 on the substrate surface 111a. The reflection suppressors 118 can be formed on the substrate surface 111a by, e.g., black printing and the like, and suppress reflection by the light from the semiconductor chips 112a on the substrate surface 111a.

Due to this, of the light emitted by the semiconductor chips 112a, even if some light is directed toward the substrate surface 111a (the light illustrated in FIG. 3 as dotted lines), the reflection suppressors 118 will suppress the light from reflecting on the substrate surface 111a. As a result, it is possible to suppress reflected light from leaking through the gaps 117.

### OTHER EMBODIMENTS

The above described first and second embodiments are explained as being suitable for use in the warning display units 110, 110A of the vehicle combination meter 100, but are not limited to such and can be widely applied as indicators and the like in various kinds of equipment and devices.

As illustrated in FIGS. 1 and 3, the substrate surface 111a of the printed substrate 111 constitutes a flat surface in the above described first and second embodiments. Then, by the chip bases 113 which have a fixed thickness ‘b’, the light-emitting elements 112a are disposed closer to the display panel 115 than the distal end portions 116a of the light-blocking walls 116 are to the display panel 115. However if, for example, recesses are formed on the substrate surface 111a at the locations facing the distal end portions 116a (facing end surfaces), it would be acceptable to have the distal end portions 116a reach into such recesses. Such a result may be considered as disposing the light-emitting elements 112a closer to the display panel 115 than the distal end portions 116a of the light-blocking walls 116 are to the display panel 115. Moreover, the regions of the substrate surface 111a where the chip bases 113 are positioned can be formed to protrude toward the display panel 115. Then, the light-emitting elements 112a corresponding to the protruding portions of the substrate surface 111a will approach the display panel 115, and the light-emitting elements 112a can be disposed even closer to the display panel 115 than the distal end portions 116a of the light-blocking walls are to the display panel 115.

What is claimed is:

1. A display device comprising:
a substrate;
a plurality of light-emitting elements including a light-emitting unit and provided on a mounting surface of the substrate;
a display panel arranged to face the mounting surface of the substrate;
a plurality of light-transmitting units provided on the display panel with respect to the plurality of light-emitting elements, the plurality of light-transmitting units allowing light emitted from the light-emitting unit to transmit therethrough; and
a light-blocking wall provided at a location corresponding to a space between mutually adjacent ones of the plurality of light-emitting elements, the light-blocking wall being positioned between the substrate and the display panel, wherein
a gap is defined between the mounting surface of the substrate and a facing end surface of the light-blocking wall that faces the substrate,
the light-emitting unit is disposed closer to the display panel than the gap is to the display panel,
the light-emitting unit is mounted on a light-emitting unit substrate that is disposed on the mounting surface of the substrate, and
the light-emitting unit is disposed closer to the display panel than the gap is to the display panel by setting a thickness of the light-emitting unit substrate to be larger than the gap.

2. (canceled)

3. The display device according to claim 1, wherein
a potting portion made of resin is provided on the light-emitting unit substrate and covers the light-emitting unit, and
a side surface of the potting portion is formed to slant toward a side of the light-emitting unit in a direction from the light-emitting unit substrate to the display panel.

4. The display device according to claim 1, wherein
a reflection suppressor is formed on the mounting surface of the substrate to suppress reflection of light emitted from the light-emitting unit.

5. A display device comprising:
a substrate;
a plurality of light-emitting elements including a light-emitting unit, the plurality of light-emitting elements being provided on a mounting surface of the substrate to be mutually adjacent;
a display panel arranged to face the mounting surface of the substrate;
a plurality of light-transmitting units provided on the display panel with respect to the plurality of light-emitting elements and allowing light emitted from the light-emitting unit to transmit therethrough;
a light-blocking wall, which isolates the plurality of light-emitting elements from one another, provided between the mounting surface of the substrate and the display panel at a location corresponding to a space between mutually adjacent ones of the plurality of light-emitting elements; and
a light-emitting unit substrate having a first surface on which the light-emitting unit is disposed and a second surface disposed on the substrate, wherein
the light-blocking wall includes a facing end surface that is spaced apart from, and faces, the mounting surface of the substrate,
the first surface of the light-emitting unit substrate is disposed closer to the display panel than the facing end surface of the light-blocking wall is to the display panel,
the mounting surface of the substrate is formed as a flat surface, and
a distance between the first surface and the second surface is set such that the first surface of the light-emitting unit substrate is disposed closer to the display panel than the facing end surface of the light-blocking wall is to the display panel.

6. (canceled)
